(19) United States
(12) Patent Application Publication
(10) Pub. No.: US 2026/0211824 A1
(43) Pub. Date: Jul. 23, 2026

(54) System and Method for ahead-of-time-scheduling of Machine Learning Model Weights Transfers Between Memories

(71) Applicant: Silicon Laboratories Inc., Austin, TX (US)

(72) Inventor: Daniel Riedler, Escondido, CA (US)

(21) Appl. No.: 19/032,261

(22) Filed: Jan. 20, 2025

(51) Int. Cl. G06F 13/28

(52) U.S. Cl. CPC G06F 13/28; G06F 2213/28

(57) ABSTRACT

Systems and methods for loading weights used by a machine learning model into local memory to accelerate execution are disclosed. A model compiler is used to determine how to separate the required weights and bias values into smaller blocks of memory that can be transferred to a buffer in a local memory device. In addition, the embedded device has two concurrently executing processes which handle the DMA transfers and the hardware accelerator. These processes are synchronized such that the DMA transfer process loads weights and bias values into one or more buffers that is then used by the hardware accelerator. While the hardware accelerator is using the data in one buffer, the DMA transfer process is loading the next set of weights and bias values into another buffer.

### Field

This disclosure describes systems and methods for loading weights used by a machine learning model into local memory to accelerate execution.

### BACKGROUND

Recently, more and more systems are implementing neural networks to perform one or more functions. For example, neural networks may be used for vision systems to identify objects in the field of vision.

Neural networks typically utilize a large amount of data, and do a significant number of computations on that data to arrive at a final result. There may be hundreds of kilobytes, or even megabytes of data that are processed by the neural network.

Additionally, embedded systems have begun to utilize neural networks. To facilitate this transition, many of these embedded systems have incorporated hardware accelerators that are special purpose devices that perform the matrix operations needed by the neural network. These hardware accelerators utilize this data, as well as weights and biases to perform the desired operations. A weight is a multiplicative factor that is applied to an input or data element, while a bias is a constant that is added to that input or data element. In other words, for a fully connected layer, the hardware accelerator may compute a value as W*(input)+B, where W is the weight and B is the bias to be applied. The hardware accelerator may also use the weights and biases to implement convolution layers.

Typically, these weights and bias values are located in memory, and are read by the hardware accelerator when needed. Because of the amount of space that is occupied by these weights and bias values, they are typically stored in a physically separate memory, which may be RAM, FLASH, non-volatile memory (NVM) or another memory device. In other words, while most embedded systems include some local memory that is typically co-located on the same die as the processing unit and the hardware accelerator, the amount of local memory is insufficient to store all of the weights and bias values needed by the neural network. Consequently, when the hardware accelerator executes, it must retrieve the requisite weights and bias values from this physically separate memory. The access time of this physically separate memory is typically much slower than the co-located memory. Thus, the hardware accelerator is often waiting to receive data before it is able to execute. FIG. 1 shows a timeline showing the accesses to memory that are made by the hardware accelerator and the execution of the hardware accelerator. Note that FIG. 1 shows three different sets of weights 10, 11, 12 and three sets of operations 20, 21, 22. The first set of weights 10 must be completely loaded into the hardware accelerator before the hardware accelerator can perform the first set of operations 20. Similarly, once execution of the first set of operations 20 is complete, the hardware accelerator is forced to be idle until the second set of weights 11 is loaded into the hardware accelerator before the second set of operations 21 may be performed. Note that this creates a very low utilization of the hardware accelerator. Further, if the accelerator requires a set of weights that were previously loaded again, such as the first set of weights 10, this first set of weights 10 must be loaded into the hardware accelerator again, further decreasing the utilization of the hardware accelerator. Further, FIG. 1 shows that the time to read the weights from the external memory is much longer than the time needed for the hardware accelerator to execute the operation.

Therefore, a system and method that increases the utilization of a hardware accelerator would be beneficial.

### SUMMARY

Systems and methods for loading weights used by a machine learning model into local memory to accelerate execution are disclosed. A model compiler is used to determine how to separate the required weights and bias values into smaller blocks of memory that can be transferred to a buffer in a local memory device. In addition, the embedded device has two concurrently executing processes which handle the DMA transfers and the hardware accelerator. These processes are synchronized such that the DMA transfer process loads weights and bias values into one or more buffers that is then used by the hardware accelerator. While the hardware accelerator is using the data in one buffer, the DMA transfer process is loading the next set of weights and bias values into another buffer.

According to one embodiment, a method of executing a machine learning (ML) model is disclosed, wherein the ML model comprises a plurality of accelerator programs, which are executed by one or more hardware accelerators. The method comprises copying a first set of weights and bias values from an external memory device to a first of a plurality of buffers in a local memory device; executing a first accelerator program, using one of the one or more hardware accelerators, after the first set of weights and bias values have been copied to the local memory device; and copying a second set of weights and bias values from the external memory device to a second of the plurality of buffers while the first accelerator program is executing. In some embodiments, the first of the plurality of buffers is released after the first accelerator program completes execution. In certain embodiments, the method comprises copying a third set of weights and bias values to the first of the plurality of buffers after the first of the plurality of buffers is released. In certain embodiments, the copying of the third set of weights and bias values is performed while a second accelerator program is executing using the second set of weights and bias values. In some embodiments, the copying is performed by a DMA controller. In some embodiments, an address of the first of the plurality of buffers is contained in metadata. In certain embodiments, the metadata contains a source address and a length of the first set of weights and bias values in the external memory device. In certain embodiments, the metadata indicates when the first of the plurality of buffers is to be released. In certain embodiments, the first of the plurality of buffers is released after the first accelerator program has completed execution. In certain embodiments, the first of the plurality of buffers is released after a layer of the ML model has completed execution, wherein a layer of the ML model comprises a plurality of accelerator programs. In certain embodiments, the metadata contains register values to be used by the one of the one or more hardware accelerators to execute the first accelerator program.

According to another embodiment, a device for executing a machine learning (ML) model is disclosed, wherein the ML model comprises a plurality of accelerator programs that utilize weights and bias values. The device comprises a processing unit; a local memory device, configured to have a plurality of buffers; an external memory device; a DMA controller to transfer weights and bias values from the external memory device to at least one of the plurality of buffers in the local memory device; a hardware accelerator that uses the weights and bias values in the local memory device to execute the plurality of accelerator programs; wherein the device comprises software that includes a ML execution process and a DMA transfer process; wherein the ML execution process does not allow execution of an accelerator program until the DMA transfer process has loaded a first set of weights and bias values into the local memory device; and wherein the DMA transfer process begins transferring a second set of weights and bias values into at least a second of the plurality of buffers in the local memory device while the accelerator program is executing using the first set of weights and bias values. In some embodiments, the DMA transfer process uses metadata to determine a starting address in the external memory device, a destination address in the local memory device and a length needed for transfer of the first set of weights and bias values. In certain embodiments, the metadata also provides a identifier for the at least one of the plurality of buffers into which the first set of weights and bias values are transferred to. In certain embodiments, the ML execution process uses the identifier to determine a source of weights and bias values for the accelerator program. In some embodiments, the ML execution process releases the at least one of the plurality of buffers after the accelerator program completes execution, and wherein the DMA transfer process monitors a status of the at least one of the plurality of buffers to determine when a new set of weights and bias values may be transferred to the at least one of the plurality of buffers.

According to another embodiment, a method of generating metadata for a machine learning (ML) model is disclosed, wherein the ML model comprises a plurality of layers, which are executed by one or more hardware accelerators. The method comprises separating each layer into a plurality of accelerator programs; identifying weights and bias values that are needed by each of the accelerator programs; assigning the weights and bias values for each accelerator program to one or more buffers; and saving identities of the accelerator programs and its associated one or more buffers as metadata. In some embodiments, the metadata also includes information regarding when the one or more buffers associated with an accelerator program are to be released. In certain embodiments, the one or more buffers are released immediately after the accelerator program has completed execution. In certain embodiments, the one or more buffers are released after all accelerator programs associated with a layer of the MP model have completed execution.

### BRIEF DESCRIPTION OF THE DRAWINGS

For a better understanding of the present disclosure, reference is made to the accompanying drawings, in which like elements are referenced with like numerals, and in which:

FIG. 1 is a timing diagram showing the operation of a hardware accelerator according to the prior art;

FIG. 2 shows the development system associated with the creation of a neural network in an embedded device;

FIGS. 3A-3C show the operation of the hardware accelerator and the DMA controller;

FIG. 4 shows the hierarchy of the machine learning model;

FIG. 5 shows the separation of the weights and bias values using subprograms; and

FIG. 6 shows the operator of the model compiler to determine buffer usage and to generate the metadata;

FIG. 7 shows one embodiment of the types of metadata that are stored on the embedded device;

FIGS. 8A-8C show the metadata associated with the Layer Configuration List according to one embodiment;

FIG. 9 shows the metadata associated with the Cache Configuration section according to one embodiment;

FIG. 10 shows the metadata associated with the Cache Transfer Configuration section according to one embodiment;

FIG. 11 shows three processes that are used to implement the operation shown in FIGS. 3A-3C;

FIG. 12 shows the operation of the ML Execution process; and

FIG. 13 shows the operation of the DMA Transfer process.

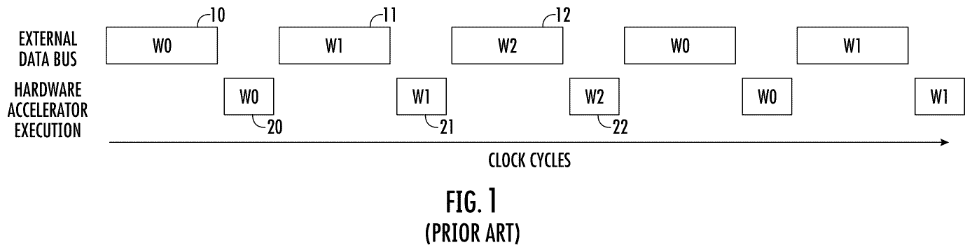

### DETAILED DESCRIPTION

This disclosure describes a system and method for increasing the utilization of a hardware accelerator by judiciously moving blocks of data from a physically separate memory to an onboard memory device.

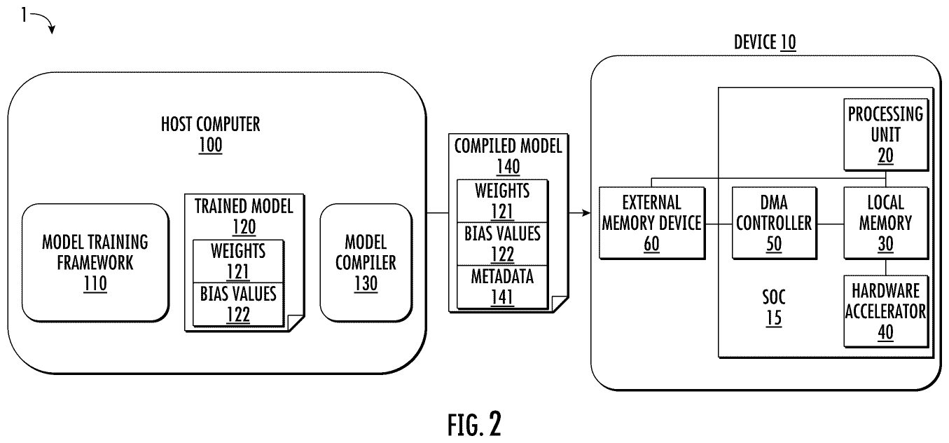

FIG. 2 shows a development system 1 that is used to generate and execute a neural network that performs efficiently. The development system includes a host computer 100 and an embedded device 10. The host computer includes hardware and software that is used to develop the application software for the embedded device 10. The host computer 100 uses a model training framework 110 to create a trained machine learning (ML) model 120. This trained ML model 120 may include a plurality of layers, such as input layers, convolution layers, fully connected layers, transpose convolution layers, and others. Some of these layers, such as the fully connected layers, may include weights 121 and bias values 122. The convolution layers utilize filters, which are created using weights 121.

This trained ML model 120 is then provided to a model compiler 130. The model compiler 130 may be a Python package that accepts the trained ML model and optimizes it for the hardware available on the embedded device 10. Internally, the model compiler 130 has several different stages it uses to optimize the trained ML model 120 for the hardware, as will be described in more detail below. The output of the model compiler 130 is a compiled model 140 with the weights 121, the bias values 122 and additional metadata 141 appended to it. This compiled model 140 is then loaded into the embedded device 10.

The embedded device 10 includes a processing unit 20. The processing unit 20 may be any suitable component, such as a microprocessor, embedded processor, an application specific circuit, a programmable circuit, a microcontroller, or another similar device. This processing unit 20 may be packaged as a system on chip (SoC) 15, such that the processing unit 20 and other functions are co-located on the same semiconductor chip.

The embedded device 10 also includes a local memory device 30. This local memory device 30 is co-located on the SoC 15 with the processing unit 20, and therefore has very fast access times. This local memory device 30 is typically a volatile memory.

The embedded device 10 also includes a hardware accelerator 40, which is also co-located in the SoC 15. This hardware accelerator 40 may be any suitable device. In at least one embodiment, the hardware accelerator 40 is a matrix vector processor (MVP) that includes multiple dedicated hardware arithmetic logic units (ALUs), a load/store unit, and a sequencer that handles array iteration and loop iteration. Note that while FIG. 2 shows one hardware accelerator 40, it is understood that multiple independent hardware accelerators, which may be the same type or different types, may be used.

Additionally, the embedded device 10 also includes a DMA controller 50, which may also be co-located in the SoC 15. The DMA controller 50 is able to access an external memory device 60, which may be a volatile memory device, such as a random access memory (RAM). Alternatively or additionally, the external memory device 60 may be a nonvolatile memory, such as a FLASH memory or electrically erasable ROM. Further, the DMA controller 50 is also able to access the local memory device 30. Thus, the DMA controller 50 is able to transfer data between the external memory device 60 and the local memory device 30. The DMA controller 50 may be a dedicated hardware circuit with programmable registers that allow a starting source address, a starting destination address and a length, to be written. Based on these values, the DMA controller 50 is able to move data from the starting source address to the starting destination address. Once loaded with these values, the DMA controller 50 is able to execute independently from the processing unit 20.

This external memory device 60 may also contain the instructions, which, when executed by the processing unit 20, enable the embedded device 10 to perform the functions described herein. In certain embodiments, the instructions may be copied to the local memory device 30 for improved speed of execution, if desired.

Although not shown, the embedded device 10 also has a power supply, which may be a battery or a connection to a permanent power source, such as a wall outlet. Further, FIG. 2 is used to illustrate the functionality of the embedded device 10, not its physical configuration. Thus, in other configurations, other or different components may be integrated into the SoC 15.

The compiled model 140 with weights 121, bias values 122 and metadata 141 may be loaded into external memory device 60, which as noted above, may be a volatile or nonvolatile memory.

The weights 121 and bias values 122 are used by the hardware accelerator 40, while the metadata 141 is used by the processing unit 20. Specifically, there may be a set of instructions referred to as the runtime ML driver, that are executed by the processing unit 20. The metadata 141 informs the runtime ML driver how to transfer weights 121 and bias values 122 from external memory device 60 to local memory device 30 via the DMA controller 50. The metadata 141 also informs the processing unit 20 how to configure the hardware accelerator 40 to read the weights 121 and bias values 122 from the local memory device 30 and execute the trained ML model 120.

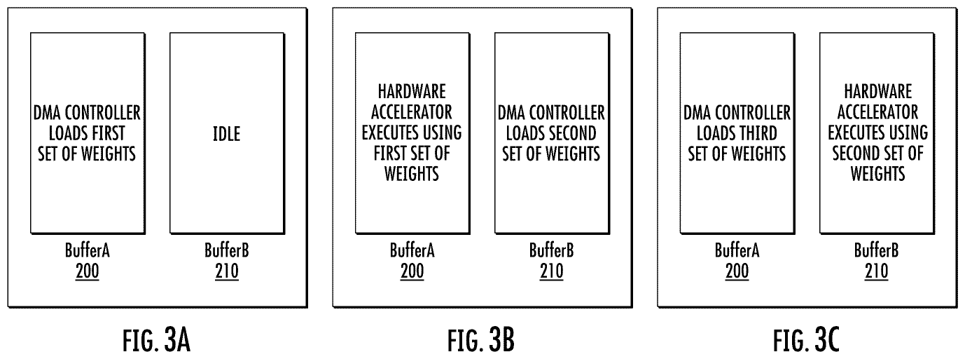

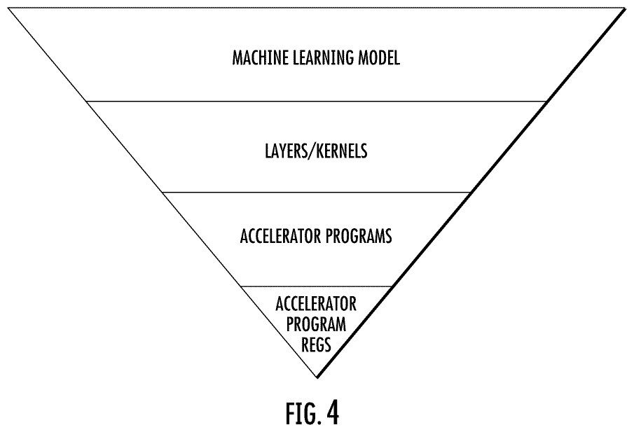

FIGS. 3A-3C show the operation of the embedded device 10 when the metadata 141 is used. FIG. 3A-3C show a pair of buffers, BufferA 200 and BufferB 210. These two buffers are located in the local memory device 30, and are accessible by the DMA controller 50 and the hardware accelerator 40. As shown in FIG. 3A, using information contained in the metadata 141, the DMA controller 50 loads a first set of weights into BufferA 200 during a first time period. In other words, the DMA controller 50 is copying weights 121 from the external memory device 60 to BufferA 200, based on information contained in the metadata 141. The DMA controller 50 may also copy bias values 122 to the local memory device 30. The bias values 122 may be disposed in the same buffer as the weights 121 or may be in a different buffer. Further, based on information contained in the metadata 141, the hardware accelerator 40 sits idle during this first time period.

At the start of the second time period, which is shown in FIG. 3B, the DMA controller 50 has completed the transfer of the first set of weights to BufferA 200. Then, the DMA controller 50 is programmed to copy a second set of weights from the external memory device 60 to BufferB 210 in the local memory device 30. At the same time, the hardware accelerator 40 is now allowed to begin execution using the first set of weights located in BufferA 200. Thus, during the second time period, the DMA controller 50 is loading weights into the second buffer, while the hardware accelerator 40 is able to execute using previously loaded weights and bias values in the first buffer.

At the start of the third time period, which is shown in FIG. 3C, the DMA controller 50 has completed the transfer of the second set of weights to BufferB 210 and the hardware accelerator 40 has finished its execution using the first set of weights. Then, the DMA controller 50 is programmed to copy a third set of weights from the external memory device 60 to BufferA 200 in the local memory device 30. At the same time, the hardware accelerator 40 is now allowed to begin execution using the second set of weights and bias values located in BufferB 210. Thus, during the third time period, the DMA controller 50 is loading weights and bias values into the first buffer, while the hardware accelerator 40 is able to execute using previously loaded weights and bias values in the second buffer.

This alternating use of buffers by the DMA controller 50 and the hardware accelerator 40 may continue until the hardware accelerator 40 has completed execution of the ML model.

Referring to FIG. 4, an exemplary machine learning (ML) model includes one or more layers. In one embodiment, each layer corresponds to a component that receives weighted inputs, transforms the weighted inputs using a set of linear or nonlinear operations, and passes the transformed values to a next layer. Each layer executes at least one kernel, which is defined as an implementation of an operation associated with specific hardware/platform capabilities. Some operations have a one-to-one mapping from operation to kernel, while other operations use multiple kernels. In general, an operation is a mathematical operation on at least one data unit (such as for example, at least one vector or multidimensional array) that produces at least one data unit as output. As an example, the hardware accelerator 40 executes a sequence of accelerator programs to speed up execution of a corresponding kernel. Each accelerator program in the sequence writes accelerator program registers with corresponding program values. For example, the processing unit 20 may write values to corresponding accelerator program registers of hardware accelerator 40. In at least one embodiment, processing unit 20 writes the accelerator program registers of hardware accelerator 40 according to Conventional Microcontroller Software Interface Standard (CMSIS) or another technique for accessing peripheral registers.

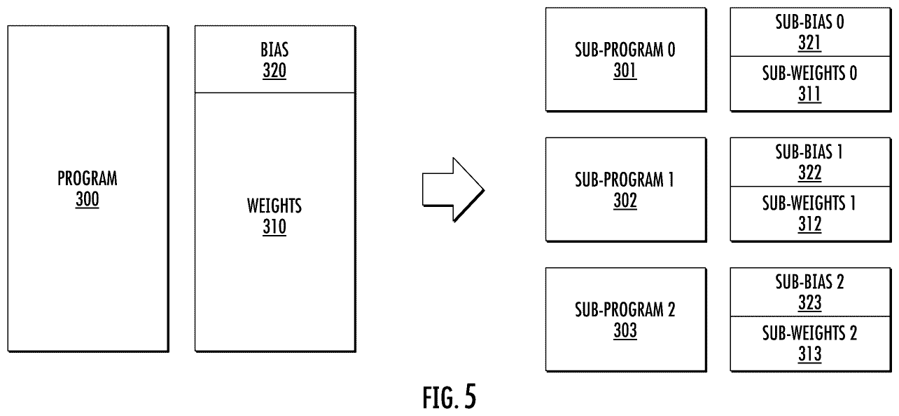

FIG. 5 shows that for a particular accelerator program 300, there are associated weights 310 and bias values 320. The amount of data that the weights 310 and the bias values 320 represent may be larger than the size of the buffers described in FIGS. 3A-3C. Thus, in certain embodiments, the model compiler 130 separates the accelerator program 300 into a plurality of subprograms, such as Sub-Program 0 301, Sub-Program 1 302 and Sub-Program 2 303. Each of these subprograms then processes only a subset of the weights 310 and bias values 320. In this way, the weights and bias values may be made to fit within the two buffers. Note that the buffers may be any suitable size, such as 16 kBytes each.

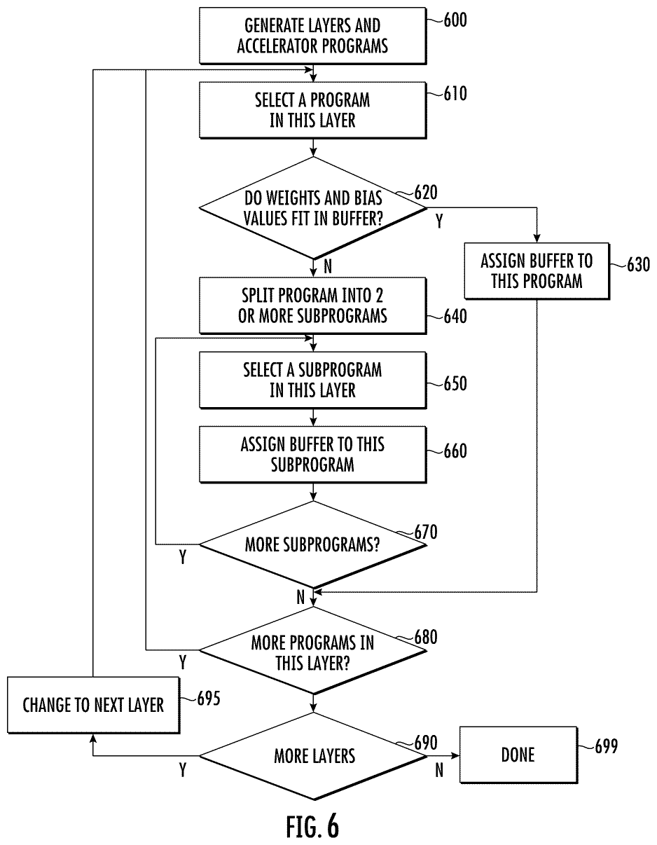

Having described the use of buffers to speed up the execution of the machine learning model, the operation of the model compiler 130 to produce the requisite weights 121, bias values 122 and metadata 141 will be described with respect to FIG. 6.

First, the model compiler 130 generates the requisite layers and accelerator programs needed to implement the machine learning model, as shown in Box 600. Next, the model compiler 130 performs a plurality of processes for each layer. First, the model compiler 130 selects a first accelerator program in the current layer, as shown in Box 610. The model compiler 130 then checks the amount of data (i.e. the weights and bias values) associated with this accelerator program, as shown in Decision Box 620. If the weights and bias values fit within the buffer, the model compiler 130 assigns a buffer to the weights and bias values, as shown in Box 630. If, however, the weights and bias values do not fit within a buffer, the model compiler 130 splits the program into two or more subprograms, as shown in Box 640. The model compiler 130 then selects one of the subprograms (see Box 650) and assigns a buffer to the weight and bias values for this subprogram, as shown in Box 660. The model compiler 130 then checks if there are other subprograms, as shown in Decision Box 670. If so, it repeats these steps for each subprogram. If all of the subprograms have been processed, the model compiler 130 checks if there are other programs that still need to be processed in this layer, as shown in Decision Box 680. If so, the model compiler 130 repeats Boxes 610-670. If there are no other programs in this layer, the model compiler 130 checks if there are other layers to process, as shown in Decision Box 690. If so, the layer to be process is changed (see Box 695) and Boxes 610-680 are repeated. If there are no more layers, the model compiler 130 is done, as shown in Box 699.

There are variations of this flowchart. For example, in some embodiments, the model compiler 130 tracks how much data has been assigned to a buffer. If there is still space in a buffer, the model compiler 130 may attempt to add weights and bias values from another program or subprogram into the same buffer. In some embodiments, if the weights and bias values cannot fit within a single buffer, the model compiler 130 may separate the weights and the bias values, such that either the weights or bias values are assigned to the buffer. In this embodiment, the other of the weights or bias values is then assigned to a different buffer, or separated into subprograms.

The metadata 141 created by the model compiler 130 is used by the hardware accelerator 40 and the DMA controller 50 to control their operations. This metadata is created by the model compiler 130 as it executes the flowchart shown in FIG. 6.

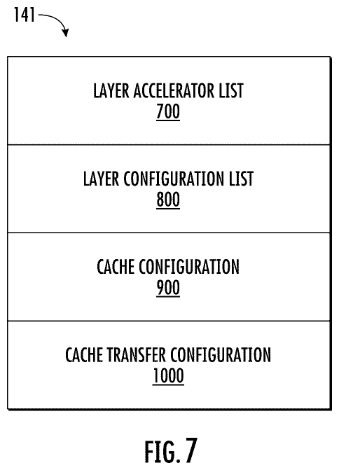

FIG. 7 shows an example of a high level representation of the metadata 141 that is created by the model compiler 130 and copied to the embedded device 10. There are four types of information that may be contained in the metadata 141. The first type is the Layer Accelerator List 700, which is a list of hardware accelerators that are used for each layer. For example, the model compiler 130 may support a variety of different hardware accelerators. This Layer Accelerator List 700 may be used to identify which accelerator (if any) is used by a particular layer.

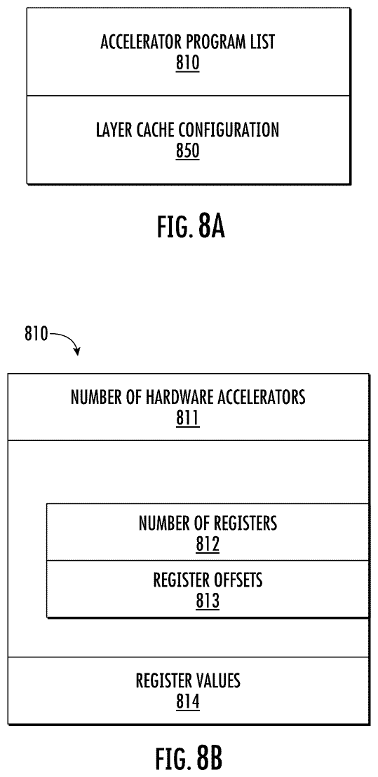

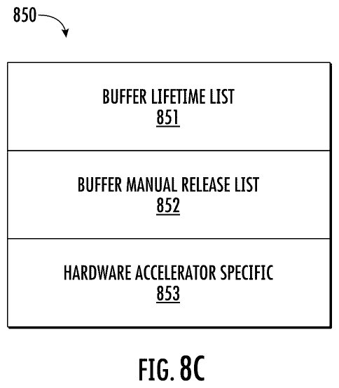

The second type of information is the Layer Configuration List 800. The Layer Configuration List 800 contains information about each compiled layer. FIGS. 8A-8C show one implementation of the Layer Configuration List 800. In this implementation, the Layer Configuration List 800 includes an Accelerator Program List 810, and a Layer Cache Configuration section 850. One example of the Accelerator Program List 810 is shown in FIG. 8B, while one example of the Layer Cache Configuration section 850 is shown in FIG. 8C.

FIG. 8B shows the details of the Accelerator Program List 810. For each accelerator program, there is a number of hardware accelerators 811 that are to be used. These hardware accelerators may include a Matrix Vector Processor (MVP), a convolution engine, a tensor sparsity engine or other accelerators. Each hardware accelerator has a set of registers that are located at a specific address in the embedded device 10. Thus, the Accelerator Program List 810 may include the number of registers 812 associated with each hardware accelerator and the address offset 813 for the register set. Finally, for each hardware accelerator, the register values 814 for the set of registers is also included.

FIG. 8C shows the details of the Layer Cache Configuration section 850 according to one embodiment. The Layer Cache Configuration section 850 provides information about the buffers and allow synchronization between the hardware accelerator 40 and the DMA controller 50. The Layer Cache Configuration section 850 includes a Buffer Lifetime List 851. This list describes when each buffer is released. For example, a buffer may be released after it is used by an accelerator program. Alternatively, a buffer may be released at the end of the processing of an entire layer. In another scenario, the buffer may be released manually, or may be unused. The Buffer Manual Release List 852 is the list of buffers that are released by the current layer when it completes execution. The hardware accelerator specific field 853 contains information that is specific to the corresponding hardware accelerator 40 that is being used.

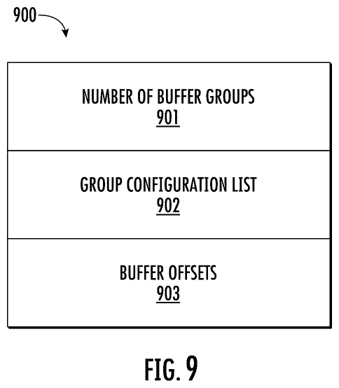

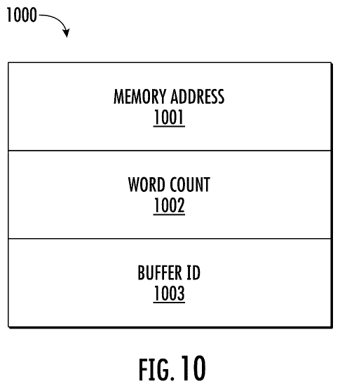

Returning to FIG. 7, the metadata 141 also includes a Cache Configuration section 900. This section contains information about the buffers that are used by the DMA controller and the hardware accelerator. As shown in FIG. 9, the Cache Configuration section 900 includes a field 901 that describes the number of buffers to be used. As described above, the buffers are used in pairs, also referred to as groups. In some embodiments, this field 901 may represent the number of groups of buffers. Additionally, the Cache Configuration section 900 includes a Group Configuration List 902. This list may be used to define attributes of a group, such as whether it is read only. Finally, the Cache Configuration section 900 includes a field 903 that contains the buffer offsets for each group. This field provides the memory address (or offset) of each buffer in each group.

Returning to FIG. 7, the metadata 141 also includes a Cache Transfer Configuration section 1000. This section provides all of the information to transfer weights 121 and bias values 122 from the external memory device 60 to the local memory device 30. As shown in FIG. 10, the Cache Transfer Configuration section 1000 includes a list of transfer attributes, one for each DMA transfer. This list of attributes includes the memory address 1001 of the data in the external memory device 60 to be transferred, the word count 1002 of the transfer, and the buffer ID 1003 that the data is to be copied to.

While FIGS. 7-10 detail the configuration of the metadata 141, it is understood that this metadata 141 may be organized differently. However, in all embodiments, the metadata 141 provides the information needed to operate the DMA controller 50 and the hardware accelerator 40.

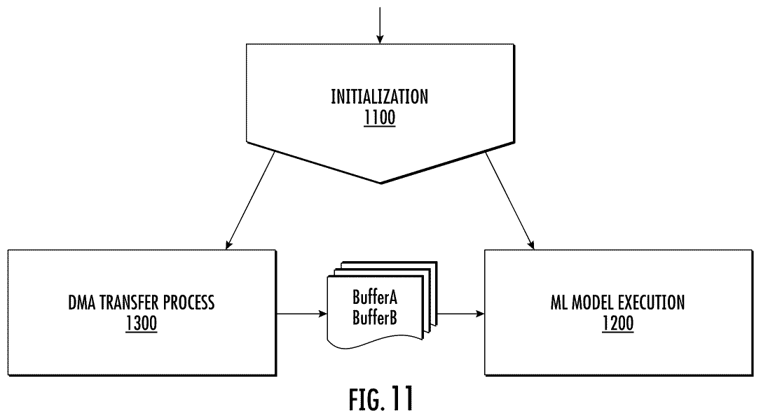

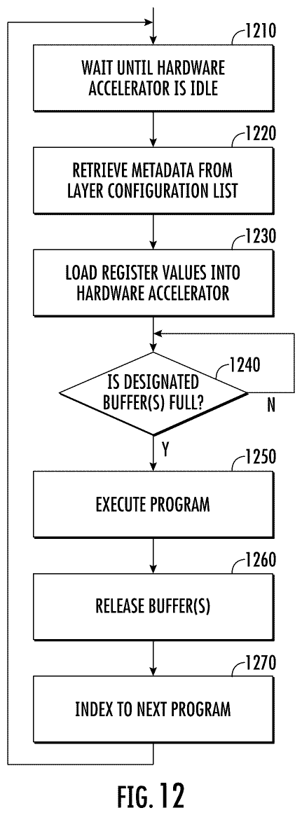

Having defined the metadata, a description of the operation of the embedded device 10 in executing a machine learning model is now presented. FIG. 11 shows the three components associated with the execution of the machine learning model in the embedded device 10. First, an initialization process 1100 executes. This process loads the metadata 141 from the compiled model 140, and initializes the hardware accelerator 40 and the DMA controller 50. This process also allocates memory for the buffers in local memory device 30.

Once the system has been initialized, the initialization process 1100 may start two concurrent processes, the machine learning (ML) execution process 1200 and the DMA transfer process 1300.

These two processes both interact with BufferA 200 and BufferB 210. These two processes are synchronized such that the ML execution process 1200 does not start an accelerator program that utilizes a buffer until it knows that the buffer is full. Note that while this figure assumes that the accelerator program uses only one buffer for its execution, it is understood that the accelerator program may require multiple buffers. In this case, the ML execution process 1200 does not start the accelerator program until all of the required buffers are filled.

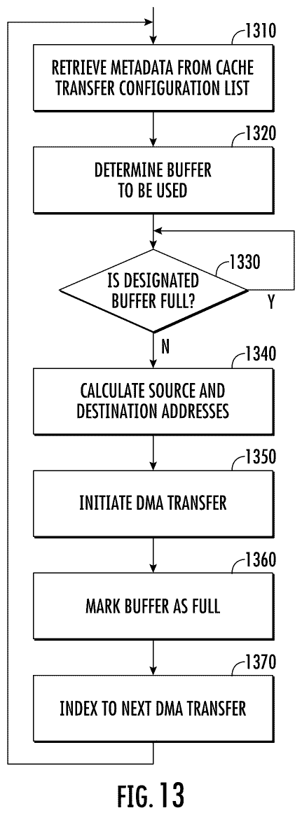

Conversely, the DMA transfer process 1300 does not start filling a buffer until it knows that it is no longer being used. FIGS. 12-13 show the operation of these two processes. FIG. 12 shows the operation of the ML Execution process 1200. First, as shown in Box 1210, the ML Execution process waits for the hardware accelerator 40 to be idle. Once it is idle, the ML Execution process 1200 retrieves metadata from the Layer Configuration list 800, as shown in Box 1220. This metadata 141 includes the next entry in the accelerator program list 810 (see FIG. 8A), which provides the register values to be loaded into the hardware accelerator 40 (see FIG. 8B). The ML Execution process 1200 also retrieves metadata from the Layer Cache Configuration section 850 (See FIG. 8C), which informs the ML Execution process which buffer or buffers will be used, and how that buffer is to be marked after use. Next, as shown in Box 1230, the ML Execution process 1200 loads the registers obtained from the metadata into the hardware accelerator 40. The ML Execution process 1200 then checks whether the designated buffer or buffers (as determined from the metadata 141) is full, as shown in Decision Box 1240. If the buffer is not full, the ML Execution process 1200 waits. If the buffer is full, the ML Execution process 1200 then instructs the hardware accelerator 40 to execute the accelerator program, as shown in Box 1250. Once the accelerator program completes, the ML Execution process 1200 may release one or more buffers, as determined from the metadata 141 and shown in Box 1260. The ML Execution process 1200 then indexes to the next program, as shown in Box 1270, and repeats this sequence.

FIG. 13 shows the operation of the DMA Transfer process 1300. First, as shown in Box 1310, the DMA Transfer process 1300 retrieves metadata 141. Specifically, the DMA Transfer process 1300 retrieves metadata from the Cache Transfer Configuration section 1000 (see FIG. 10). Based on this information, the DMA Transfer process 1300 determines the buffer to be filled, as shown in Box 1320. The DMA Transfer process 1300 then checks whether this buffer is marked as full, as shown in Decision Box 1330. If so, this indicates that the hardware accelerator 40 is still using this buffer. In this case, the DMA Transfer process simply waits. If the buffer is not marked as full, the DMA Transfer process 1300 calculates the source and destination addresses, as shown in Box 1340. It then initiates the DMA transfer, as shown in Box 1350. After the DMA transfer is complete, the DMA Transfer process 1300 marks the buffer as full, as shown in Box 1360. Finally, the DMA Transfer process 1300 indexes to the next DMA transfer, as shown in Box 1370 and repeats this sequence.

The coordination of the ML Execution process 1200 and the DMA Transfer process 1300 result in the use of buffers that was shown in FIGS. 3A-3C.

The present system and method has many advantages. In one test, the hardware accelerator 40 was a Matrix Vector Processor and the machine learning model was a convolutional neural network. When the weights and bias values were stored in the external memory device 60, the execution of the machine learning model consumed 2000 milliseconds. This machine learning model was then compiled using the model compiler 130 described herein, such that buffers in the local memory device 30 were used to hold the weight and bias values for the hardware accelerator 40. In this configuration, execution of the machine learning model consumed only 173 milliseconds, which is less than 10% of the time of the original model. Furthermore, the use of two buffers that are used in an alternating manner minimizes the amount of space that is required in the local memory device 30 to implement this approach. In fact, the local memory usage was increased by only 40 kBytes.

In addition, the amount of information that is stored as metadata allows this approach to be used with different hardware accelerators, and different numbers of buffer groups. This allows customization of the approach to the specific configuration of the embedded device 10.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of executing a machine learning (ML) model, wherein the ML model comprises a plurality of accelerator programs, which are executed by one or more hardware accelerators, the method comprising:
copying a first set of weights and bias values from an external memory device to a first of a plurality of buffers in a local memory device;
executing a first accelerator program, using one of the one or more hardware accelerators, after the first set of weights and bias values have been copied to the local memory device; and
copying a second set of weights and bias values from the external memory device to a second of the plurality of buffers while the first accelerator program is executing.

2. The method of claim 1, wherein the first of the plurality of buffers is released after the first accelerator program completes execution.

3. The method of claim 2, further comprising copying a third set of weights and bias values to the first of the plurality of buffers after the first of the plurality of buffers is released.

4. The method of claim 3, wherein the copying of the third set of weights and bias values is performed while a second accelerator program is executing using the second set of weights and bias values.

5. The method of claim 1, wherein the copying is performed by a DMA controller.

6. The method of claim 1 wherein an address of the first of the plurality of buffers is contained in metadata.

7. The method of claim 6, wherein the metadata contains a source address and a length of the first set of weights and bias values in the external memory device.

8. The method of claim 6, wherein the metadata indicates when the first of the plurality of buffers is to be released.

9. The method of claim 8, wherein the first of the plurality of buffers is released after the first accelerator program has completed execution.

10. The method of claim 8, wherein the first of the plurality of buffers is released after a layer of the ML model has completed execution, wherein a layer of the ML model comprises a plurality of accelerator programs.

11. The method of claim 6, wherein the metadata contains register values to be used by the one of the one or more hardware accelerators to execute the first accelerator program.

12. A device for executing a machine learning (ML) model, wherein the ML model comprises a plurality of accelerator programs that utilize weights and bias values, the device comprising:
a processing unit;
a local memory device, configured to have a plurality of buffers;
an external memory device;
a DMA controller to transfer weights and bias values from the external memory device to at least one of the plurality of buffers in the local memory device;
a hardware accelerator that uses the weights and bias values in the local memory device to execute the plurality of accelerator programs;
wherein the device comprises software that includes a ML execution process and a DMA transfer process;
wherein the ML execution process does not allow execution of an accelerator program until the DMA transfer process has loaded a first set of weights and bias values into the local memory device; and
wherein the DMA transfer process begins transferring a second set of weights and bias values into at least a second of the plurality of buffers in the local memory device while the accelerator program is executing using the first set of weights and bias values.

13. The device of claim 12, wherein the DMA transfer process uses metadata to determine a starting address in the external memory device, a destination address in the local memory device and a length needed for transfer of the first set of weights and bias values.

14. The device of claim 13, wherein the metadata also provides a identifier for the at least one of the plurality of buffers into which the first set of weights and bias values are transferred to.

15. The device of claim 14, wherein the ML execution process uses the identifier to determine a source of weights and bias values for the accelerator program.

16. The device of claim 12, wherein the ML execution process releases the at least one of the plurality of buffers after the accelerator program completes execution, and wherein the DMA transfer process monitors a status of the at least one of the plurality of buffers to determine when a new set of weights and bias values may be transferred to the at least one of the plurality of buffers.

17. A method of generating metadata for a machine learning (ML) model, wherein the ML model comprises a plurality of layers, which are executed by one or more hardware accelerators, the method comprising:
separating each layer into a plurality of accelerator programs;
identifying weights and bias values that are needed by each of the accelerator programs;
assigning the weights and bias values for each accelerator program to one or more buffers; and
saving identities of the accelerator programs and its associated one or more buffers as metadata.

18. The method of claim 17, wherein the metadata also includes information regarding when the one or more buffers associated with an accelerator program are to be released.

19. The method of claim 18, wherein the one or more buffers are released immediately after the accelerator program has completed execution.

20. The method of claim 18, wherein the one or more buffers are released after all accelerator programs associated with a layer of the MP model have completed execution.
